(19) United States
(12) Patent Application Publication
(10) Pub. No.: US 2015/0120541 A1
(43) Pub. Date: Apr. 30, 2015

(54) Contribution Destination Identification and Processing

(71) Applicant: Bank of America Corporation, Charlotte, NC (US)

(72) Inventors: Tyler R. Johnson, Tega Cay, SC (US); Michael Lee Orr, Charlotte, NC (US); Therese H. Willis, Apopka, FL (US)

(73) Assignee: Bank of America Corporation, Charlotte, NC (US)

(21) Appl. No.: 14/063,221

(22) Filed: Oct. 25, 2013

(51) Int. Cl. G06Q 30/02; G06Q 20/10

(52) U.S. Cl. CPC G06Q 30/0279; G06Q 20/1085
USPC 705/43; 705/44

(57) ABSTRACT

Systems, methods and apparatuses for identifying a plurality of contribution destinations and a geographic location associated with each contribution destination. In some examples, a plurality of transaction devices or systems (e.g., automated teller machines (ATMs), online banking systems, mobile banking applications, and the like) may also be associated with a geographic location. In some arrangements, the contribution destination(s) associated with a geographic location will be transmitted to any transaction devices associated with the same geographic location. The contribution destinations may then be presented to a user or customer with a request for a gift or donation to one or more of the contribution destinations via the transaction device or system (e.g., during the course of another transaction initiated by the user).

### BACKGROUND

People are often looking for ways to help those in need. Often, at grocery stores, and the like, customers have an option to give a donation or gift to charity. However, the option is typically to donate to just one charity and it may not be a charity that specifically aids those in the home town of the customer. Further, conventional systems of giving may involve time and resources to getting the donation program established in order to offer an option to donate to customers. This may be inefficient and ineffective if an urgent needs develops and people are in need of donated funds quickly (e.g., when a natural disaster strikes).

### SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure relate to methods, computer-readable media, and apparatuses for identifying a plurality of contribution destinations and a geographic location associated with each contribution destination. In some examples, a plurality of transaction devices or systems (e.g., automated teller machines (ATMs), online banking systems, mobile banking applications, and the like) may also be associated with a geographic location. In some arrangements, the contribution destination(s) associated with a geographic location will be transmitted to any transaction devices associated with the same geographic location. The contribution destinations may then be presented to a user or customer with a request for a gift or donation to one or more of the contribution destinations via the transaction device or system (e.g., during the course of another transaction initiated by the user).

### BRIEF DESCRIPTION OF THE DRAWINGS

The present disclosure is illustrated by way of example and not limited in the accompanying figures in which like reference numerals indicate similar elements and in which:

FIG. 1 illustrates an example operating environment in which various aspects of the disclosure may be implemented.

FIG. 2 is an illustrative block diagram of workstations and servers that may be used to implement the processes and functions of certain aspects of the present disclosure according to one or more aspects described herein.

FIG. 3 illustrates an example contribution destination identification and processing system according to one or more aspects described herein.

FIG. 4 is an example method of identifying contribution destination(s) and transmitting them to a transaction device or system according to one or more aspects described herein.

FIG. 5 is an example method of providing identified contribution destination(s) to a user in the course of a transaction according to one or more aspects described herein.

FIGS. 6A-6D illustrate example user interfaces for displaying one or more contribution destinations to a user with a request for a donation and receiving user input associated with the donation according to one or more aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized, and that structural and functional modifications may be made, without departing from the scope of the present claimed subject matter.

It is noted that various connections between elements are discussed in the following description. It is noted that these connections are general and, unless specified otherwise, may be direct or indirect, wired or wireless, and that the specification is not intended to be limiting in this respect.

Various example arrangements described herein relate to identifying one or more contribution destinations. A contribution destination, as used herein, may include an organization, fund, and the like that may request donations or gifts. For instance, contribution destinations may include charities, relief funds, and the like, arranged to raise money for a cause, organization, or the like. The contribution destinations may be stored in a database of contribution destinations and each contribution destination may be associated with at least one geographic region. Accordingly, the contribution destinations associated with a geographic region may be transmitted to one or more transaction devices or systems (e.g., an automated teller machine (ATM), online banking application, mobile banking application, and the like) associated with the geographic region associated with the contribution destination. Accordingly, a user initiating a transaction at a transaction device or system may be prompted to make a donation to one or more of the contribution destinations transmitted to that transaction device or system.

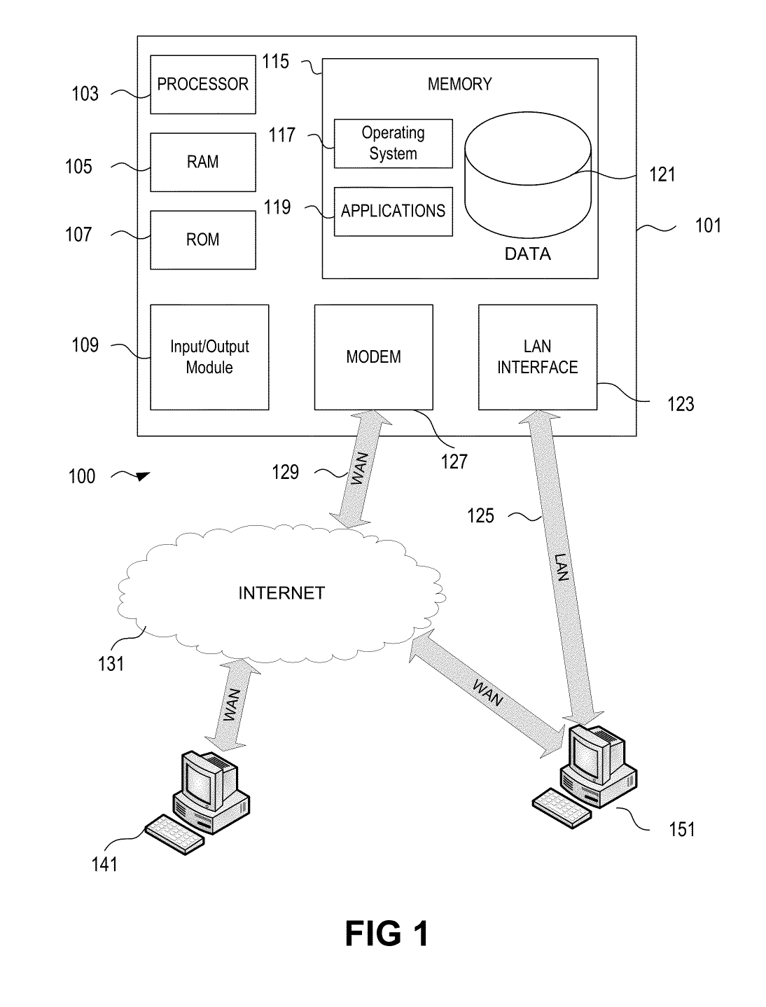

FIG. 1 depicts an illustrative operating environment in which various aspects of the present disclosure may be implemented in accordance with one or more example embodiments. Referring to FIG. 1, computing system environment 100 may be used according to one or more illustrative embodiments. Computing system environment 100 is only one example of a suitable computing environment and is not intended to suggest any limitation as to the scope of use or functionality contained in the disclosure. Computing system environment 100 should not be interpreted as having any dependency or requirement relating to any one or combination of components shown in illustrative computing system environment 100.

Computing system environment 100 may include computing device 101 having processor 103 for controlling overall operation of computing device 101 and its associated components, including random-access memory (RAM) 105, read-only memory (ROM) 107, communications module 109, and memory 115. Computing device 101 may include a variety of computer readable media. Computer readable media may be any available media that may be accessed by computing device 101, may be non-transitory, and may include volatile and nonvolatile, removable and non-removable media implemented in any method or technology for storage of information such as computer-readable instructions, object code, data structures, program modules, or other data. Examples of computer readable media may include random access memory (RAM), read only memory (ROM), electronically erasable programmable read only memory (EEPROM), flash memory or other memory technology, compact disk read-only memory (CD-ROM), digital versatile disks (DVD) or other optical disk storage, magnetic cassettes, magnetic tape, magnetic disk storage or other magnetic storage devices, or any other medium that can be used to store the desired information and that can be accessed by computing device 101.

Although not required, various aspects described herein may be embodied as a method, a data processing system, or as a computer-readable medium storing computer-executable instructions. For example, a computer-readable medium storing instructions to cause a processor to perform steps of a method in accordance with aspects of the disclosed arrangements is contemplated. For example, aspects of the method steps disclosed herein may be executed on a processor on computing device 101. Such a processor may execute computer-executable instructions stored on a computer-readable medium.

Software may be stored within memory 115 and/or storage to provide instructions to processor 103 for enabling computing device 101 to perform various functions. For example, memory 115 may store software used by computing device 101, such as operating system 117, application programs 119, and associated database 121. Also, some or all of the computer executable instructions for computing device 101 may be embodied in hardware or firmware. Although not shown, RAM 105 may include one or more applications representing the application data stored in RAM 105 while computing device 101 is on and corresponding software applications (e.g., software tasks), are running on computing device 101.

Communications module 109 may include a microphone, keypad, touch screen, and/or stylus through which a user of computing device 101 may provide input, and may also include one or more of a speaker for providing audio output and a video display device for providing textual, audiovisual and/or graphical output. Computing system environment 100 may also include optical scanners (not shown). Exemplary usages include scanning and converting paper documents, e.g., correspondence, receipts, and the like, to digital files.

Computing device 101 may operate in a networked environment supporting connections to one or more remote computing devices, such as computing devices 141 and 151. Computing devices 141 and 151 may be personal computing devices or servers that include any or all of the elements described above relative to computing device 101. Computing devices 141 or 151 may be a mobile device (e.g., smart phone) communicating over a wireless carrier channel.

The network connections depicted in FIG. 1 may include local area network (LAN) 125 and wide area network (WAN) 129, as well as other networks. When used in a LAN networking environment, computing device 101 may be connected to LAN 125 through a network interface or adapter in communications module 109. When used in a WAN networking environment, computing device 101 may include a modem in communications module 109 or other means for establishing communications over WAN 129, such as Internet 131 or other type of computer network. The network connections shown are illustrative and other means of establishing a communications link between the computing devices may be used. Various well-known protocols such as transmission control protocol/Internet protocol (TCP/IP), Ethernet, file transfer protocol (FTP), hypertext transfer protocol (HTTP) and the like may be used, and the system can be operated in a client-server configuration to permit a user to retrieve web pages from a web-based server. Any of various conventional web browsers can be used to display and manipulate data on web pages.

The disclosure is operational with numerous other general purpose or special purpose computing system environments or configurations. Examples of well-known computing systems, environments, and/or configurations that may be suitable for use with the disclosed embodiments include, but are not limited to, personal computers (PCs), server computers, hand-held or laptop devices, smart phones, multiprocessor systems, microprocessor-based systems, set top boxes, programmable consumer electronics, network PCs, minicomputers, mainframe computers, distributed computing environments that include any of the above systems or devices, and the like.

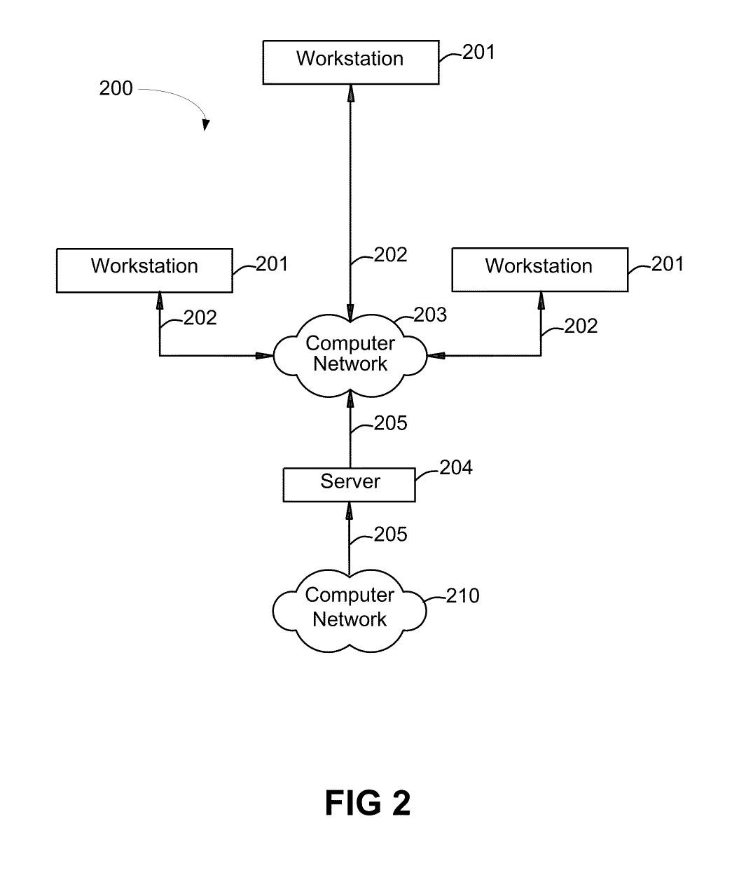

FIG. 2 depicts an illustrative block diagram of workstations and servers that may be used to implement the processes and functions of certain aspects of the present disclosure in accordance with one or more example embodiments. Referring to FIG. 2, illustrative system 200 may be used for implementing example embodiments according to the present disclosure. As illustrated, system 200 may include one or more workstation computers 201. Workstation 201 may be, for example, a desktop computer, a smartphone, a wireless device, a tablet computer, a laptop computer, and the like. Workstations 201 may be local or remote, and may be connected by one of communications links 202 to computer network 203 that is linked via communications link 205 to server 204. In system 200, server 204 may be any suitable server, processor, computer, or data processing device, or combination of the same. Server 204 may be used to process the instructions received from, and the transactions entered into by, one or more participants.

Computer network 203 may be any suitable computer network including the Internet, an intranet, a wide-area network (WAN), a local-area network (LAN), a wireless network, a digital subscriber line (DSL) network, a frame relay network, an asynchronous transfer mode (ATM) network, a virtual private network (VPN), or any combination of any of the same. Communications links 202 and 205 may be any communications links suitable for communicating between workstations 201 and server 204 (e.g. network control center), such as network links, dial-up links, wireless links, hard-wired links, as well as network types developed in the future, and the like. A virtual machine may be a software implementation of a computer that executes computer programs as if it were a standalone physical machine.

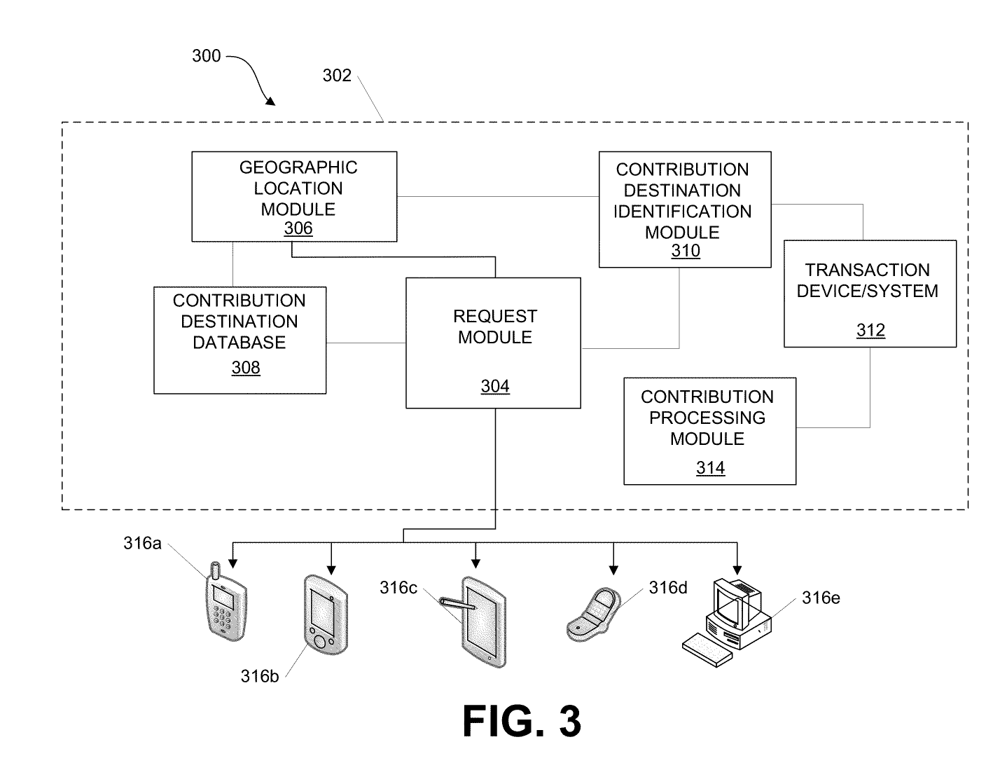

FIG. 3 illustrates one example contribution destination identification and processing system 300 according to one or more aspects described herein. In some examples, the contribution destination identification and processing system 300 may be part of, internal to or associated with an entity 302. The entity 302 may be a corporation, university, government entity, and the like. In some examples, the entity 302 may be a financial institution, such as a bank. Although various aspects of the disclosure may be described in the context of a financial institution, nothing in the disclosure shall be construed as limiting the contribution destination identification and processing system to use within a financial institution. Rather, the system may be implemented by various other types of entities.

The contribution destination identification and processing system 300 may include one or more modules that may include hardware and/or software configured to perform various functions within the system 300. For instance, the system, 300 may include a contribution destination database 308. The contribution destination database 308 may include information identifying one or more contribution destinations, such as charitable organizations, funds, or other contribution destinations, as well as information identifying a geographic location or region associated with each charitable organization, fund or other contribution destination. In some examples, one or more of the contribution destinations may be established by the entity to raise money for a particular cause (e.g., the entity implementing the system may establish a fund to raise money for a particular cause and donations may be requested from users of one or more transaction devices or systems of the entity, as will be discussed more fully below). The entity may then collect the contributions for the fund or other contribution destination and will distribute it to the appropriate contribution destination as designated by the user making the donation.

The contribution destination database 308 may include one or more tables identifying contribution destinations that may be provided to customers or other users with an offer to accept a donation or gift on behalf of that contribution destination. In some examples, the offer may be made to the customer or user at a transaction device or system 312, such as an automated teller machine (ATM), online banking system, mobile banking application, and the like. Presentation of the offer and the transaction device or system 312 will be discussed more fully below.

The contribution destination identification and processing system 300 may further include a request module 304. The request module 304 may receive, such a via one or more computing devices 316a-316e, a request to add a particular contribution destination to the contribution destination database or queue. For instance, upon identification of a particular contribution destination that is not in the contribution destination database 308 (e.g., a new charity, a particular fund drive for a recent tragedy, and the like), a request may be submitted to the system 300 (e.g., via the request module 304) to add the identified contribution destination to the contribution destination database 308 and thereby attempt to solicit donations to the contribution destination (e.g., via the transaction device or system 312). The request may be received from a computing device, such as a smart phone 316a, personal digital assistant (PDA) 316b, tablet computing device 316c, cell phone 316d or other computing device 316e.

Upon approval of the request to add the identified contribution destination, the contribution destination will be added to the contribution destination database 308. Approval of the request may be based on a variety of factors that may be particular to the entity 302. For instance, the approval process may rely on factors such as pre-existing association with the contribution destination, overall goals or values of the contribution destination, and the like. In some examples, approval of the request to add the additional contribution destination may be a manual process. The approval process may, in some arrangements, be automatically performed by the system 300.

The contribution destination identification and processing system 300 may further include a geographic location module 306. The geographic location module 306 may determine or identify a geographic location associated with each contribution destination in the contribution destination database 308. The geographic location module 306 may also identify a geographic location associated with any newly added contribution destinations or contribution destinations pending approval. The geographic location information may include a city, state, township, zip code, region, and the like of the contribution destination. This may aid in providing targeted offers or requests for donations via the transaction devices or systems 312, as will be discussed more fully below.

In some examples, a contribution destination may be associated with one or more geographic location. For instance, a small town may be affected by the loss of a local firefighter and may set up a fund to raise money for the family of the firefighter. Accordingly, the fund set up may be associated with the town, county, or the like, of the firefighter. In another example, a particular charity may operate in several states and would thus be associated with each of the states in which it operates. In yet another example, a contribution destination may be a nationwide charity and, thus, the contribution destination may be associated with all geographic locations (e.g., the entire country). In still another example, a tragedy may strike a particular geographic location but may gain national attention (e.g., a particularly devastating natural disaster may strike a small area but several regions, or an entire country, may be interested in helping those affected by making a donation). Accordingly, the contribution destination (e.g., a fund drive to raise money to help with relief efforts of the tragedy) may be associated with several geographic locations.

The contribution destination identification and processing system 300 may further include a contribution destination identification module 310. The contribution destination identification module 310 may identify one or more contribution destinations to present to customers (e.g., to request a gift or donation) based on the geographic locations of the contribution destinations and the transaction device or system 312. For instance, the system may include a plurality of transaction devices or systems (identified by transaction device or system block 312 in FIG. 3). The transaction devices or systems may include ATMs, online banking systems, mobile banking applications, and the like. The transaction devices or systems 312 may include an identifier providing a geographic location of the transaction device or system. For instance, an ATM may include an identifier identifying a location of the ATM. In another example, a mobile banking application may identify location information of a user based on received user input (e.g., an address of a user) or from global positioning system (GPS) data identifying a geographic location of a user. An online banking system may identify a geographic location of a user from information provided by the user (e.g., address information).

Accordingly, the contribution destination identification module 310 may identify one or more transaction devices or systems 312 to which one or more contribution destinations should be transmitted for display to users, based on the geographic locations of the contribution destination and the transaction devices or systems 312. For instance, the contribution destination identification module 310 may cross-reference the geographic location information of various transaction devices or systems with the geographic location information of the contribution destinations in the system 300 to determine which transaction devices or systems should receive which contribution destinations. The contribution destinations may then be transmitted to the transaction devices or systems and presented to one or more users for selection (e.g., to make a gift or donation).

In some arrangements, the contribution destination identification module 310 may identify some or all of the transaction devices or systems 312 associated with a particular geographic location (e.g., city, state, township, zip code, region, and the like). The contribution destination identification module 310 may then identify some or all of the contribution destinations associated with each geographic location. The contribution destination identification module may then transmit, to some or all of the transaction devices or systems 312 associated with a particular geographic location, some or all of the contribution destinations associated with that particular geographic location.

In some examples, the transaction devices or systems 312 may be ATMs, online banking systems, mobile banking applications, and the like. The transaction devices or systems may receive the contribution destinations associated with the geographic location of the transaction device or system 312 and may present the contribution destinations to one or more users. For instance, if the transaction device or system 312 is an ATM, during a transaction being conducted by the user at the ATM, the user may be prompted with a request to donate to one or more of the contribution destinations. The user may accept or decline the offer to donate. Additional details associated with providing the contribution destination(s) to a user and acceptance of an offer to donate will be discussed more fully below.

The contribution destination identification and processing system 300 may further include a contribution processing module 314. If a user accepts an offer to make a gift or donation to one or more of the provided contribution destinations, the contribution processing module 314 may receive the donation and desired amount and process the donation. That is, an amount of the donation, contribution destination, user who made the donation, and the like, of the donation may be processed and/or stored by the contribution processing module 314 to ensure that the proper amount of funds is later transmitted to the correct contribution destination.

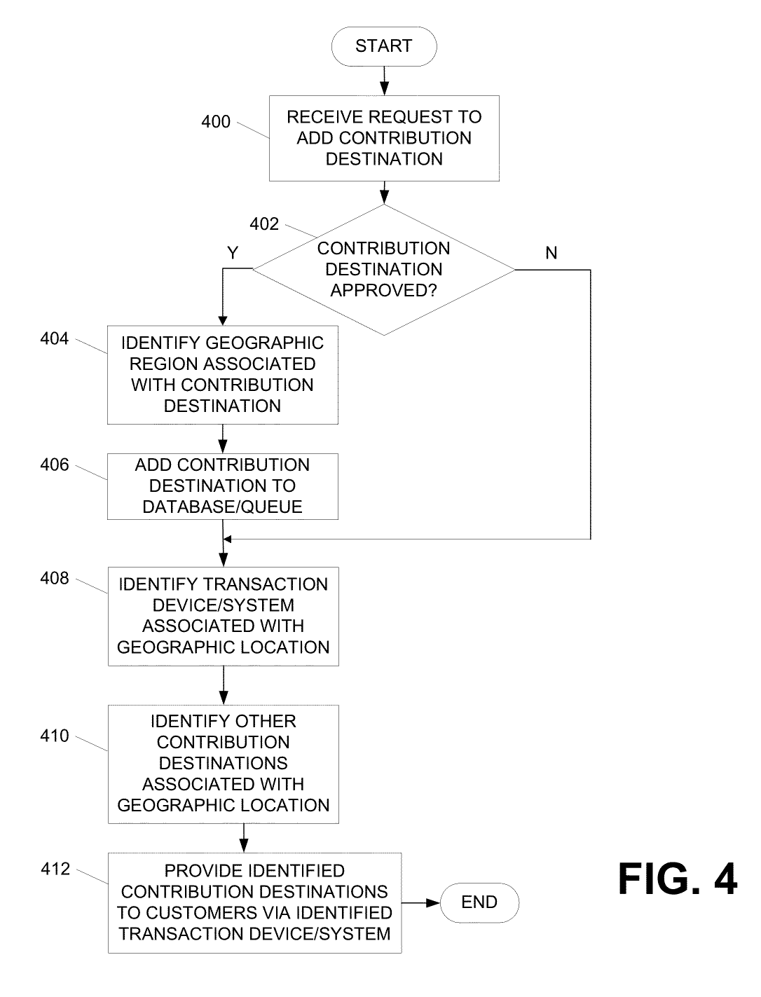

FIG. 4 illustrates one example method of identifying contribution destinations and transmitting the contribution destinations to one or more transaction devices or systems. In step 400, a request to add a contribution destination may be received. For instance, the request may be received by a request module of the system 300 from a computing device. The request may be processed, either manually or by the system, to determine whether the contribution destination meets the requirements or deciding factors of the entity implementing the system.

In some arrangements, processing the request to determine whether the contribution destination will be added to the database of contribution destinations may be performed relatively quickly. For instance, in some arrangements, the contribution destination may be associated with a fund established to assist with an immediate need (e.g., a natural disaster, loss of a local service person, and the like). The sooner funds may be collected an distributed to those in need, the better. Accordingly, decisions regarding the approval of the addition of a contribution destination may be made in real-time or near real-time upon learning of the fund, tragedy, need, and the like.

In step 402, a determination is made as to whether the request to add the contribution destination is approved. If, in step 402, the request to add the contribution destination is approved, one or more geographic regions associated with the contribution destination may be identified in step 404. In step 406, the contribution destination, and associated geographic information, may be added to the contribution destination database or queue for presentation to one or more customers or users.

Once the new contribution destination has been added or, alternatively, upon a determination in step 402 that the request to add the contribution destination has been denied, transaction devices or systems associated with a particular geographic location may be identified in step 408. In some arrangements, step 400, 402, 404 and 406 may be optional steps and the process may begin with step 408.

As discussed above, the transaction devices or systems may include ATMs, online banking systems, mobile banking applications, and the like. The geographic location or locations associated with a transaction device or system may be a town, city, state, country, zip code, region, locality, and the like.

In step 410, one or more contribution destinations associated with the geographic location are identified. The contribution destinations may include one or more charitable organizations, funds, and the like associated with the geographic location. In step 412, the identified contribution destinations may be transmitted to the identified transaction devices or systems associated with the geographic location in step 412. The contribution destinations may be provided to the user(s), e.g., during a transaction initiated by the user. For instance, in the process of withdrawing funds from an ATM, a user may be presented with a user interface requesting a donation, or providing an opportunity to donate to, one of the contribution destinations transmitted to that transaction device or system. The contribution destinations may be presented in, for example, a list to the user, from which the user may select one or more contribution destinations. In some examples, a contribution destination may be associated with multiple geographic locations and, accordingly, the contribution destination would be transmitted to transaction devices or systems in the multiple geographic locations.

The arrangements described herein allow for, in some examples, making targeted requests for donations from users within the same region or locality as the contribution destination or need associated therewith. For instance, a local charity may be in need of funds and accordingly, a targeted request of users within the same locality as the charity may be made. This may provide users with an opportunity to give or donate to a contribution destination that is serving a local need and thereby keeps the aid provided in the user's community, which may be important to the user.

By providing multiple contribution destinations to a user, the user may select a contribution destination that has meaning for the user (e.g., a charitable organization or fund in his/her area, a charitable organization or fund raising money for a cause the user is committed to, and the like).

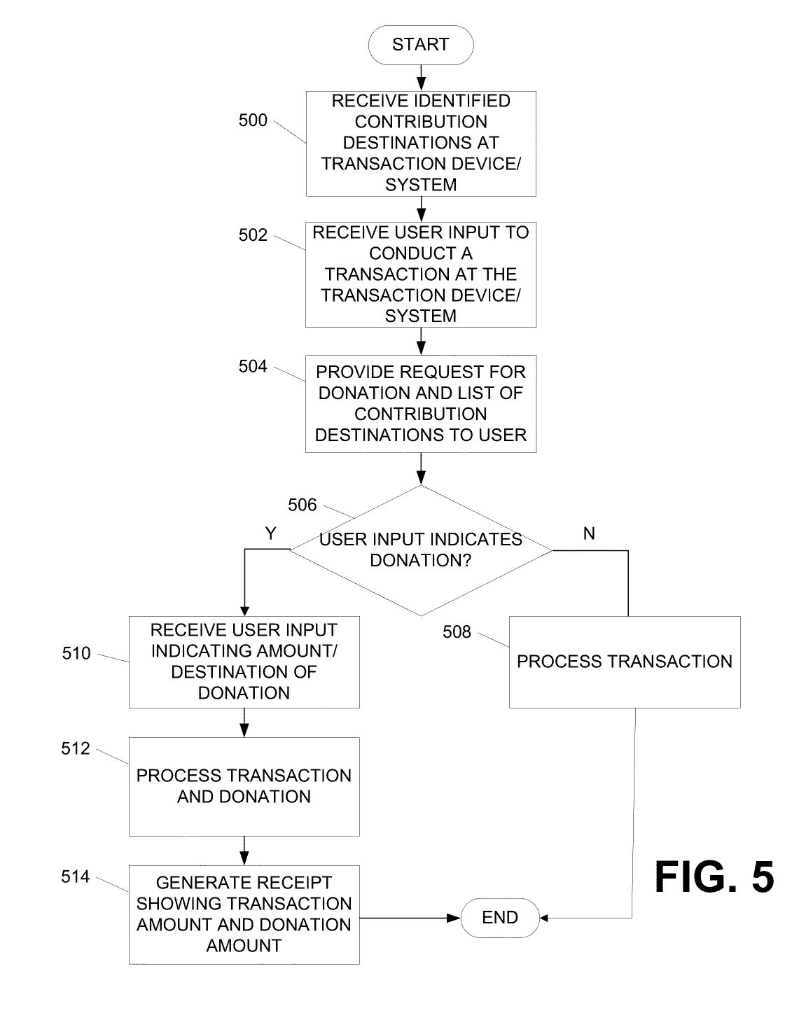

FIG. 5 illustrates another example method of providing contribution destination(s) to a user for selection according to one or more aspects described herein. In step 500, identified contribution destination(s) are received at a transaction device or system. As discussed above, the contribution destinations may be identified based on geographic location information associated with the contribution destination and the transaction device or system.

In step 502, user input requesting a transaction may be received at the transaction device or system. For instance, a user may initiate a transaction at an ATM, via an online banking service or via a mobile banking application. The transaction initiated may include a withdrawal of funds, check cashing, cash advance, check deposit, cash deposit, transfer, and the like. In step 504, a request for a donation or gift from the user may be presented to the user. The request may include identification (e.g., a list) of the contribution destinations available at that transaction device or system. In some examples, the request for donation and/or presentation of the available contribution destinations may be provided to the user during the transaction initiated by the user. For instance, upon selecting a type of transaction (e.g., withdrawal, transfer, deposit, and the like) the user may be provided with a user interface requesting the donation and providing the list of contribution destination(s) for selection. In another arrangement, the request for donation may be provided to the user in a main menu (e.g., an initial menu, a menu providing various transaction options, and the like). This arrangement may permit a user to select an option to make a donation without requiring any other transactions by the user or any prior initiation of another type of transaction.

In step 506, a determination is made as to whether user input has been received indicating that a user is or will be making a donation to one or more contribution destinations. If the received user input indicates that the user will not be making a donation to one or more of the contribution destinations, the user's transaction (e.g., the transaction initiated in step 502) may be processed in step 508.

Alternatively, if, in step 506, the received user input indicates that a donation will be made, user input is then received in step 510 identifying an amount of the donation or gift and the particular contribution destination to which the donation is being made. In step 512, the transaction (e.g., the transaction initiated by the user in step 502) and the donation may be processed by the system. In step 514, a receipt may be generated indicating a record of the transaction as well as a record of the donation made. The receipt may include an amount of the donation, particular contribution destination to which the donation was made, and the like.

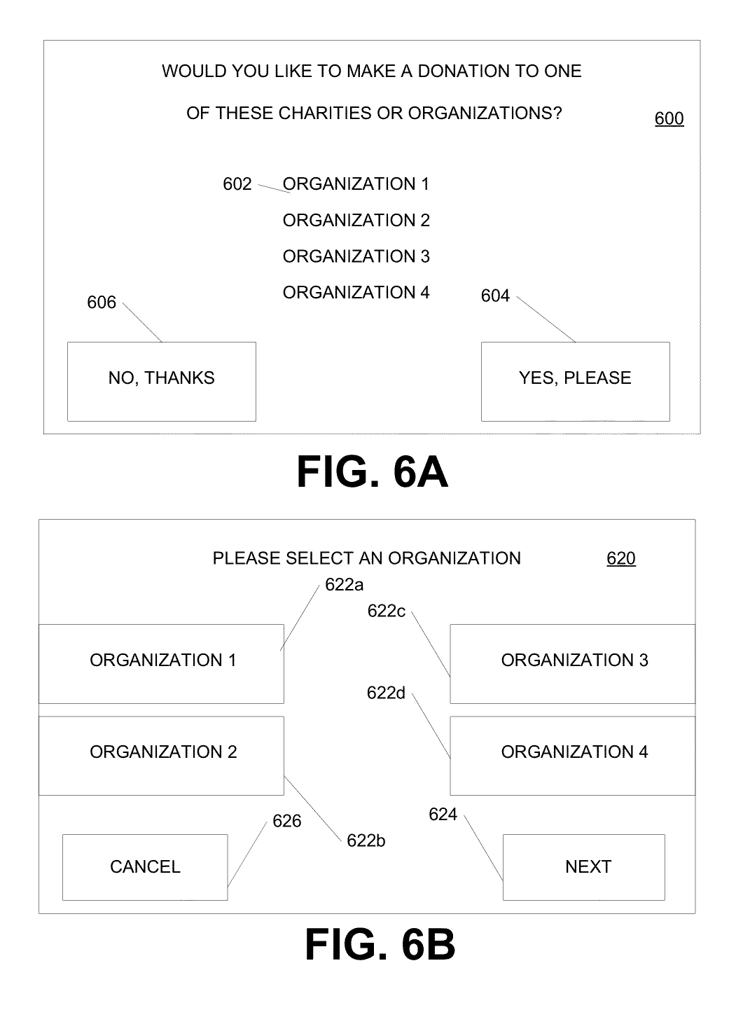

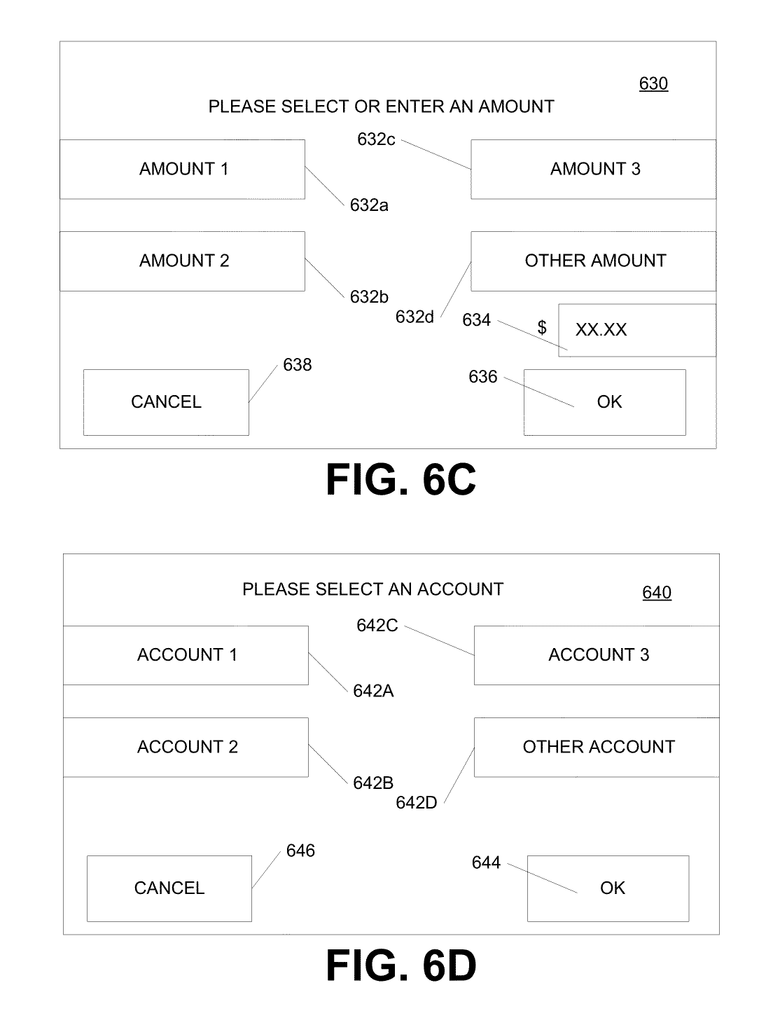

FIGS. 6A-6D illustrate example user interfaces that may be provided to a user or customer at a transaction device or system (e.g., ATM, online banking system, mobile banking application, and the like) configured to receive user input regarding a donation to a contribution destination. In FIG. 6A, user interface 600 includes an offer provided to the customer to make a donation to one of the contribution destinations (e.g., organizations 1-4) listed in field 602. The contribution destinations identified in field 602 may be transmitted to the transaction device or system based on a geographic location associated with each contribution location and with the transaction device or system, as discussed above. In some arrangements, the contribution destinations provided in field 602 may be arranged in order or priority. For instance, contribution destinations with an urgent, pressing, or time sensitive need may be provided at or near the top of the list, while other, ongoing needs or contribution destinations may be presented further down the list. For example, a contribution donation requesting a donation to raise money for victims of a recent natural disaster may be positioned at or near a top of the list, while a contribution destination raising money for medical research may be listed at or near the bottom. Although all the contribution destinations are providing money for worthy causes, the contribution destinations having a more immediate need may be prioritized and provided near the top of the list. The prioritization may be performed manually (e.g., by a system administrator) or may be performed automatically (e.g., upon indication of a time-sensitive nature of the contribution destination when the contribution destination is approved). Various other methods of prioritizing may be used without departing from the invention.

User interface 600 may be displayed to a user upon selection of a donation option on a main menu, upon a user initiating a transaction, at a predetermined point during the transaction (e.g., after selection of a type of transaction, after selection of an amount of the transaction, and the like) or at or near an end of the transaction. If a user desires to make a donation to one of the organizations listed in field 602, the user may select “YES, PLEASE” option 604. Alternatively, if the user does not desire to make a donation or gift to one of the contribution destinations identified in field 602, the user may select “NO, THANKS” option 606 and may return to a previous interface, advance to the next interface associated with the transaction, or the like.

Selection of “YES, PLEASE” option 604 from user interface 600 may prompt display of another user interface 620 in FIG. 6B. Interface 620 may provide, for selection, the contribution destinations indicated in field 602 of interface 600. For instance, contribution destinations 622a-622d may each be displayed and available for selection by the user. Once the user has selected a contribution destination 622a-622d, the user may select “NEXT” option 624 to continue processing the donation. Alternatively, the user may select “CANCEL” option 626 to return to a previous user interface or continue with the previously initiated transaction.

Selection of “NEXT” option 624 from interface 620 may prompt display of another user interface, such as interface 630 in FIG. 6C. Interface 630 includes various amounts 632a-632c that a user may select to donate. The amounts may be any amount. A user may also select “other amount” 632d. Upon selection of this option, the user may input (e.g., using a keypad, touchscreen keypad, or the like) a desired amount to donate. The desired amount may be input in field 634. Once the user has selected an amount, the user may select “OK” option 636 to process the donation. Alternatively, the user may select “CANCEL” option 638 to return to a previous user interface or continue with the transaction initiated by the user.

Selection of “OK” option from interface 630 may prompt display of another user interface 640 in FIG. 6D. Interface 640 permits a user to select an account from which to withdraw the funds for the donation. The user may select one of accounts 1-3 642a-642c or may select “other account” 642d option to choose from a list of other available accounts. In some examples, a user may be a customer of the transaction device or system requesting the donation (e.g., the user is a customer of the financial institution associated with the ATM at which the user has initiated the transaction). Accordingly, the user may select from any of the accounts the user may have with that financial institution.

In some examples, a cash deposit may be made, e.g., at an ATM, as the donation. For instance, a user may be depositing a check at the ATM but may desire to input cash funds into the ATM to make a donation. Accordingly, one or more user interfaces may be configured to select “insert cash donation” to receive a deposit of cash that will then be donated to the desired contribution destination.

In another example, a user initiating the transaction at the transaction device or system may not be a customer of or have an account with the financial institution (e.g., a first financial institution) associated with that transaction device or system (e.g., the user is not a customer of the first financial institution associated with that ATM or doesn't have an account at that first financial institution. Instead, the user is accessing accounts at another financial institution (e.g., a second financial institution) from the ATM of the first financial institution). In these examples, the accounts presented in interface 640 (e.g., accounts 642a-642c) may be accounts associated with the user at the second financial institution (e.g., accounts linked to the card used to initiate the transaction at the ATM). In some arrangements, the user may be limited to only those accounts linked to that particular card. In other examples, the user may also access other accounts not linked to the card but held by the second financial institution. In some arrangements, a donation made using funds held by the second financial institution may be delayed in being received by the contribution destination due to one or more holds placed on the transaction to ensure sufficient funds exist to make the donation.

The user interfaces illustrated in FIGS. 6A-6D are merely some example user interfaces that may be displayed to a user. Various other user interfaces or arrangements for receiving user input regarding the donation may be used without departing from the invention.

The arrangements described herein encompass a dynamic system that may permit modification of contribution destinations at different transaction devices or systems very quickly and efficiently, in order to collect and distribute funds to those in need as quickly as possible. The systems, methods, apparatuses, and the like, described herein may provide an efficient system to request donations from users or customers and may provide a targeted list of contribution destinations based on the geographic location of the transaction device or system and contribution destination.

Further, the system may provide a record of a donation made via a receipt which may indicate an amount or other details of the transaction initiated by the user, as well as an amount, contribution destination, and the like, of the donation made. The system may also provide an account detail or summary that may be provided as a service to the contribution destination as a record of donations made. The account detail or summary may be sorted by transaction device or system, geographic location, and the like, and may include a list of users who made a donation, as well as an amount of each donation made.

Various aspects described herein may be embodied as a method, an apparatus, or as one or more computer-readable media storing computer-executable instructions. Accordingly, those aspects may take the form of an entirely hardware embodiment, an entirely software embodiment, or an embodiment combining software and hardware aspects. Any and/or all of the method steps described herein may be embodied in computer-executable instructions stored on a computer-readable medium, such as a non-transitory computer readable medium. Additionally or alternatively, any and/or all of the method steps described herein may be embodied in computer-readable instructions stored in the memory of an apparatus that includes one or more processors, such that the apparatus is caused to perform such method steps when the one or more processors execute the computer-readable instructions. In addition, various signals representing data or events as described herein may be transferred between a source and a destination in the form of light and/or electromagnetic waves traveling through signal-conducting media such as metal wires, optical fibers, and/or wireless transmission media (e.g., air and/or space).

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps illustrated in the illustrative figures may be performed in other than the recited order, and that one or more steps illustrated may be optional in accordance with aspects of the disclosure. Further, one or more aspects described with respect to one figure or arrangement may be used in conjunction with other aspects associated with another figure or portion of the description.

What is claimed is:

1. An apparatus, comprising:
at least one processor; and
a memory storing computer-readable instructions that, when executed by the at least one processor, cause the apparatus to:
receive a request to provide a first contribution destination to a plurality of users for selection;
determine a geographic location associated with the first contribution destination;
receive approval of the request to provide the first contribution destination to the plurality of customers;
add the first contribution destination to a database of approved contribution destinations;
identify a plurality of transaction devices within the determined geographic location of the first contribution destination; and
transmit at least the first contribution destination to the plurality of transaction devices within the determined geographic location.

2. The apparatus of claim 1, wherein the first contribution destination is a charitable organization associated with the geographic region; and further including identifying, from the database of contribution destinations, at least a second contribution destination associated with the determined geographic location, wherein transmitting the at least the first contribution destination to the plurality of transaction devices includes transmitting the first contribution destination and the identified at least a second contribution destination to the plurality of customers.

3. The apparatus of claim 2, wherein the second contribution destination is associated with the determined geographic location and at least one other geographic location.

4. The apparatus of claim 1, wherein the database of approved contribution destinations includes contribution destinations associated with multiple geographic regions.

5. The apparatus of claim 1, wherein the database of approved contribution destinations includes at least one contribution destination associated with all identified geographic locations.

6. The apparatus of claim 1, wherein the plurality of transaction devices include a plurality of automated teller machines (ATMs) and further including providing at the ATM, an option to the plurality of customers to make a donation to the first contribution destination.

7. The apparatus of claim 6, wherein the option to make a donation to the first contribution destination is provided to the plurality of customers upon authentication of a user at the ATM.

8. The apparatus of claim 6, wherein the option to make a donation to the first contribution destination is provided to the plurality of customers in addition to other transaction options.

9. An apparatus, comprising:
at least one processor; and
a memory storing computer-readable instructions that, when executed by the at least one processor, cause the apparatus to:
determine a geographic location associated with each transaction device of a plurality of transaction devices;
select, from the plurality of transaction devices, a transaction device and identify a geographic location associated with the transaction device;
identify, from a database of contribution destinations, at least one contribution destination associated with the identified geographic location associated with the transaction device; and
transmit to the transaction device, the identified at least one contribution destination.

10. The apparatus of claim 9, further including instructions that, when executed, cause the apparatus to:
receive user input initiating a transaction at the transaction device; and
responsive to receiving user input, display the identified at least one contribution destination to the user with a request to make a donation to the identified at least one contribution destination.

11. The apparatus of claim 10, further including instructions that, when executed, cause the apparatus to:
receive user input to make a donation to the identified at least one contribution destination;
process the donation;
process the transaction initiated at the transaction device; and
generate a receipt identifying an amount of the transaction and an amount of the donation.

12. The apparatus of claim 11, wherein the receipt further includes a name of the contribution destination to which the donation was made.

13. The apparatus of claim 9, wherein the transaction device is one of an ATM, online banking system, or mobile banking application.

14. The apparatus of claim 9, wherein identifying at least one contribution destination includes identifying a plurality of contribution destinations and at least one contribution destination of the plurality of contribution destinations is associated with multiple geographic locations.

15. One or more non-transitory computer-readable media having computer-executable instructions stored thereon that, when executed, cause at least one computing device to:
determine a geographic location associated with each transaction device of a plurality of transaction devices;
select, from the plurality of transaction devices, a transaction device and identify the geographic location associated with the transaction device;
identify, from a database of contribution destinations, at least one contribution destination associated with the identified geographic location associated with the transaction device; and
transmit to the transaction device, the identified at least one contribution destination.

16. The one or more non-transitory computer readable media of claim 15, further including instructions that, when executed, cause the computing device to:
receive user input initiating a transaction at the transaction device; and
responsive to receiving user input, display the identified at least one contribution destination to the user with a request to make a donation to the identified at least one contribution destination.

17. The one or more non-transitory computer readable media of claim 16, further including instructions that, when executed, cause the computing device to:
receive user input to make a donation to the identified at least one contribution destination;
process the donation;
process the transaction initiated at the transaction device; and
generate a receipt identifying an amount of the transaction and an amount of the donation.

18. The one or more non-transitory computer readable media of claim 17, wherein the receipt further includes a name of the contribution destination to which the donation was made.

19. The one or more non-transitory computer readable media of claim 15, wherein the transaction device is one of an ATM, online banking system, or mobile banking application.

20. The one or more non-transitory computer readable media of claim 15, wherein identifying at least one contribution destination includes identifying a plurality of contribution destinations and at least one contribution destination of the plurality of contribution destinations is associated with multiple geographic locations.
